(19) United States
(12) Patent Application Publication
(10) Pub. No.: US 2018/0173847 A1
(43) Pub. Date: Jun. 21, 2018

(54) ESTABLISHING A MACHINE LEARNING MODEL FOR CANCER ANTICIPATION AND A METHOD OF DETECTING CANCER BY USING MULTIPLE TUMOR MARKERS IN THE MACHINE LEARNING MODEL FOR CANCER ANTICIPATION

(71) Applicants: JANG-JIH LU, TAIPEI CITY (TW); CHUN-HSIEN CHEN, TAOYUAN CITY (TW); HSIN-YAO WANG, CHIAYI CITY (TW); YING-HAO WEN, TAIPEI CITY (TW)

(72) Inventors: JANG-JIH LU, TAIPEI CITY (TW); CHUN-HSIEN CHEN, TAOYUAN CITY (TW); HSIN-YAO WANG, CHIAYI CITY (TW); YING-HAO WEN, TAIPEI CITY (TW)

(21) Appl. No.: 15/382,212

(22) Filed: Dec. 16, 2016

(51) Int. Cl. G06F 19/24; C40B 30/02; G06F 19/18

(52) U.S. Cl. CPC G06F 19/24; G06F 19/18; C40B 30/02

(57) ABSTRACT

A method of establishing a machine learning model for cancer anticipation includes collecting test results of a plurality of tumor markers of a plurality of eligible individuals and corresponding conditions of cancer; performing a variable selection process on the collected data to select a plurality of robust variables; and using the selected variables, numerals, and conditions of cancer by cooperating with a machine learning method to establish a cancer anticipation model. A method of detecting cancer by using a plurality of tumor markers in a machine learning model for cancer anticipation is also provided.

### BACKGROUND OF THE INVENTION

### 1. Field of the Invention

The invention relates to cancer detections and more particularly to establishing a machine learning model for cancer anticipation and a method of detecting cancer by using multiple tumor markers in the machine learning model for cancer anticipation.

### 2. Description of Related Art

Conventionally, oral cancer, breast cancer, colorectal cancer and cervical cancer are among the most common types of cancer detected by, for example, screen tests. These types of cancer can be detected in their early stages without significant symptoms. However, other types of cancer cannot be detected by screening.

Other methods have been developed for early detection of the other types of cancer. For example, lung cancer may be detected on chest radiographs or computed tomography scans, colorectal cancer may be diagnosed by obtaining a sample of the colon during a colonoscopy, and liver cancer may be diagnosed by blood tests and medical imaging with confirmation by tissue biopsy. However, each of these methods is capable of detecting only a specific type of cancer. A patient is required to do a number of tests if he or she desires to early detect many types of cancer. This has the disadvantages of inconvenience, high expenditure, and subjecting the patient to excessive radiation and/or hurt.

The test results of tumor markers are interpreted by physicians for cancer detection. The conventional art is highly operator dependent. The interpretation of test results may be subjective and variation is possible between different physicians. Moreover, tumor markers were developed for a specific cancer individually. Combing multiple tumor markers for cancer detection lacks proper way of validation, analysis, and interpretation for real clinical application. These issues have limited the application of multiple tumor markers in cancer detection.

Thus, the need for improvement still exists.

### SUMMARY OF THE INVENTION

One object of the invention is to provide a method of establishing machine learning models for cancer anticipation, the method comprising the steps of (A) collecting test results of a plurality of tumor markers of a plurality of eligible individuals and corresponding conditions of cancer; (B) performing a variable selection process on the collected data to select a plurality of robust variables; and (C) using the selected variables, numerals, and conditions of cancer by cooperating with a machine learning method to establish a cancer anticipation model.

Another object of the invention is to provide a method of detecting cancer by using a plurality of tumor markers in machine learning models for cancer anticipation, the method comprising the steps of (A) collecting samples of an eligible individual; (B) analytical measurement of a plurality of tumor markers in the collected samples to obtain test results; (C) entering the test results into the machine learning models for analysis; and (D) anticipating cancer risk of the eligible individual.

The method of detecting cancer by using a plurality of tumor markers in a machine learning model for cancer anticipation has the following advantages and benefits in comparison with the conventional art: Accuracy and time reduction of cancer detection can be obtained. An effective model for anticipating cancer by using machine learning methods can be established because there are considerable amount of information contained in the tumor markers. A medical employee may know more about health and cancer risk of a patient by conducting a cancer detection on patients by using multiple tumor markers. Samples are easy to collect. It is possible of collecting samples in a single sampling. No radiation exposure, no suffering from discomfort because of endoscope, and no anesthesia risk are involved. Samples collection can be done by a minimally-invasive manner. Compliance with cancer detection can be improved and cancer detection in the general population is made possible. Detection for many types of cancer for people without specific symptoms is made possible. Cancer detection by using multiple tumor markers has several benefits. It is safe, objective, cost effective, and capable of detecting many types of cancer at a time. Multiple tumor markers for cancer detection can be analyzed in an automatic system, and thereby greatly increases the accuracy, objectiveness, and reproducibility.

The above and other objects, features and advantages of the invention will become apparent from the following detailed description taken with the accompanying drawings.

### BRIEF DESCRIPTION OF THE DRAWINGS

FIG. 1 is a flow chart illustrating a method of establishing a machine learning model for cancer anticipation according to the invention;

FIG. 2 is a flow chart illustrating a method of detecting cancer by using multiple tumor markers in a machine learning model for cancer anticipation according to the invention;

FIG. 3A shows ROC (receiver operating characteristic) curves of various tumor markers for cancer screening (male);

FIG. 3B shows ROC curves of various machine learning models for cancer screening (male);

FIG. 3C shows ROC curves of various tumor markers for cancer screening (female); and

FIG. 3D shows ROC curves of various machine learning models for cancer screening (female).

### DETAILED DESCRIPTION OF THE INVENTION

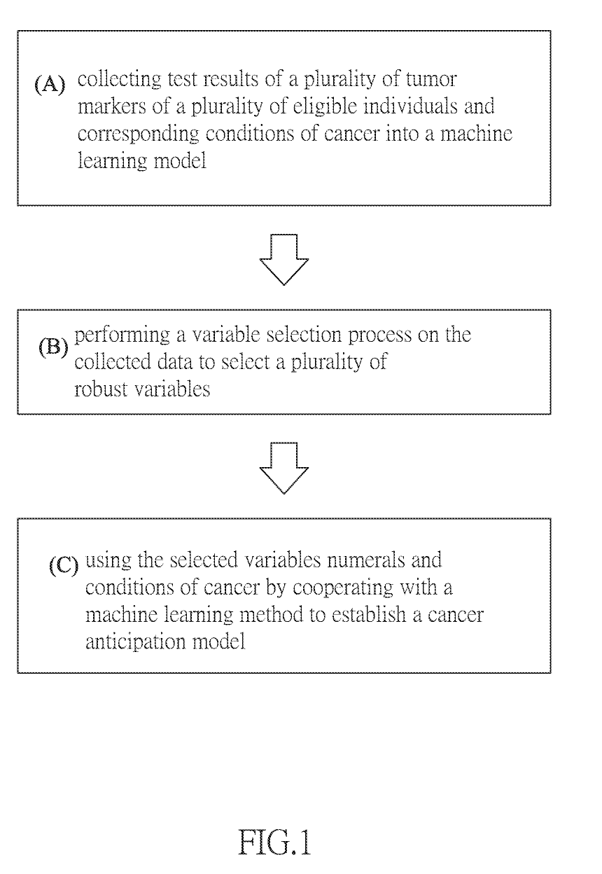

Referring to FIG. 1, a method of establishing a machine learning model for cancer anticipation according to the invention is illustrated. The method comprises the steps of: (A) collecting test results of a plurality of tumor markers of a plurality of eligible individuals and corresponding conditions of cancer; (B) performing a variable selection process on the collected data to select a plurality of robust variables; and (C) using the selected variables, numerals, and conditions of cancer by cooperating with a machine learning method to establish a cancer anticipation model.

Preferably, the machine learning method is LR (logistic regression), KNN (K nearest neighbor), SVM (support vector machine), artificial neural network, decision tree, Bayes' theorem, or any combination of the above.

Preferably, the conditions of cancer include “cancerous” or “non-cancerous”, “early stage” or “late stage” (e.g. TNM cancer staging system), and types of cancer such as liver cancer, lung cancer, or colorectal cancer.

Preferably, the date of analytically measuring tumor markers of a patient is one day to three years earlier than the date of determining a patient having corresponding conditions of cancer.

Preferably, the machine learning model is established based on sensitivity, specificity, PPV (positive predictive value), NPV (negative predictive value), accuracy, AUC (area under the curve), and Youden for performance evaluation.

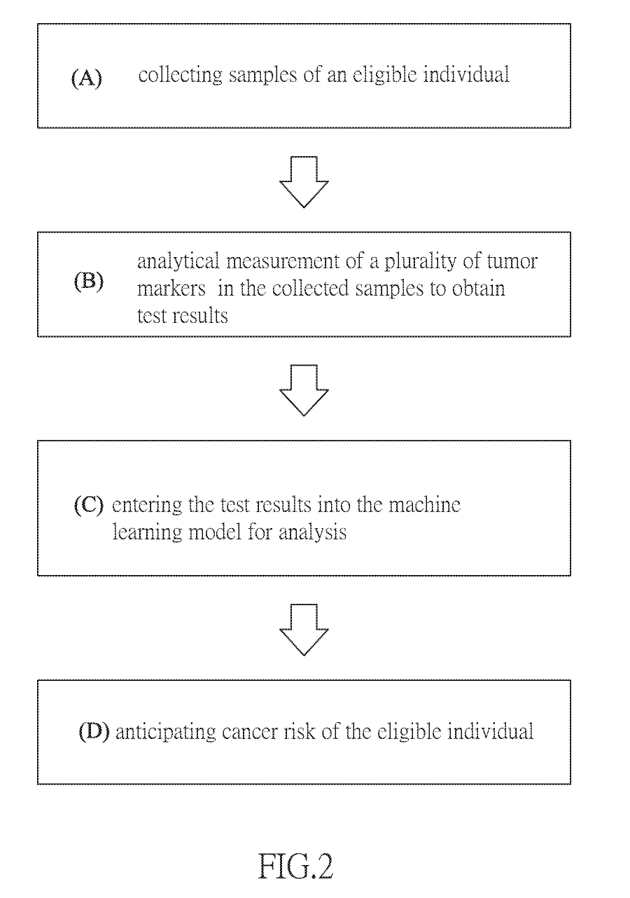

Referring to FIG. 2, a method of detecting cancer by using multiple tumor markers in a machine learning model for cancer anticipation according to the invention is illustrated. The method comprises the steps of: (A) collecting samples of an eligible individual; (B) analytical measurement of a plurality of tumor markers in the collected samples to obtain test results; (C) entering the test results into the machine learning model for analysis; and (D) anticipating cancer risk of the eligible individual. Thus, a subsequent management may be performed on the patient based on the cancer risk.

Preferably, the samples of a patient include serum, urine, saliva, sweat, feces, chest fluid, abdominal fluid, and cerebrospinal fluid.

Preferably, the multiple tumor markers include AFP (Alpha Fetal Protein), CEA (Carcinoembryonic Antigen), CA19-9 (Carbohydrate Antigen 19-9), CYFRA21-1 (Cytokeratin Fragment 21-1), SCC (Squamous Cell Carcinoma Antigen), PSA (Prostate Specific Antigen), CA15-3 (Carbohydrate Antigen), CA125 (Carbohydrate Antigen 125), EBV IgA (Epstein-Barr Virus IgA), CA27-29 (Carbohydrate Antigen), Beta-2-microglobulin, Beta-hCG (Beta-human Chorionic Gonadotropin), CD 177 (Cluster of Differentiation 177), CD 20 (Cluster of Differentiation 20), CgA (Chromogranin A), HE 4 (Human Epididymis Secretory Protein 4), LDH (Lactate Dehydrogenase), Thyroglobulin, NSE (Neuron-specific Enolase), Nuclear Matrix Protein 22, and PD-L1 (Programmed Death Ligand 1).

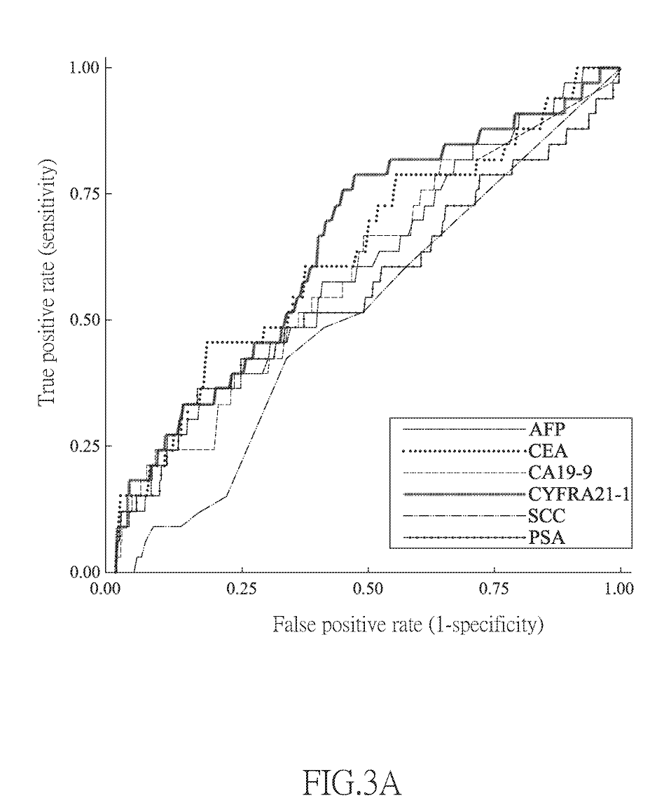

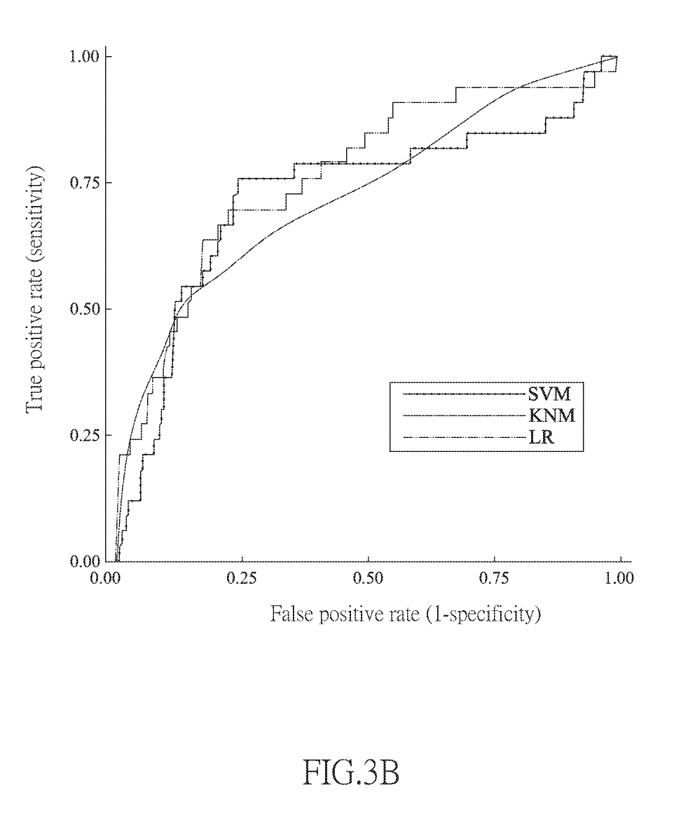

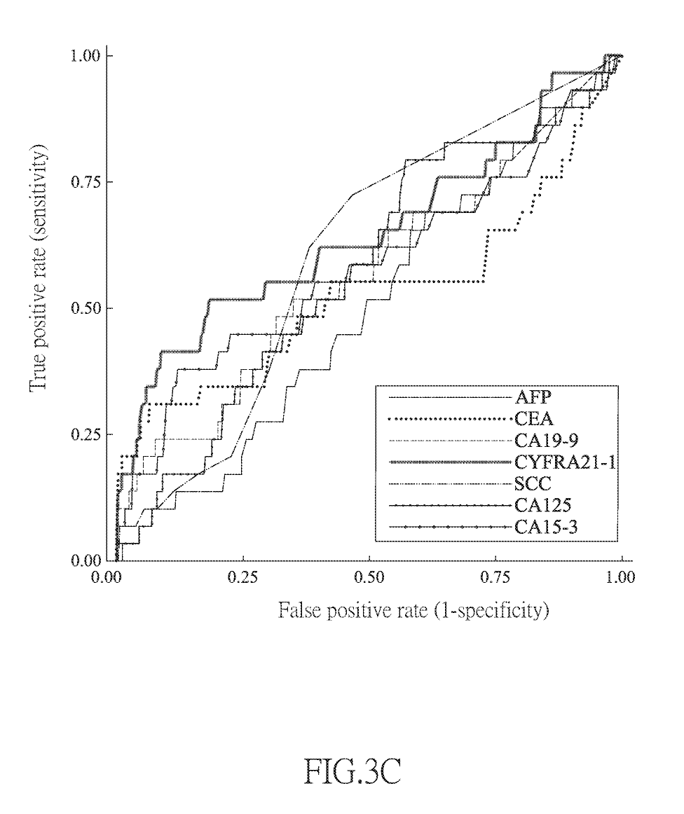

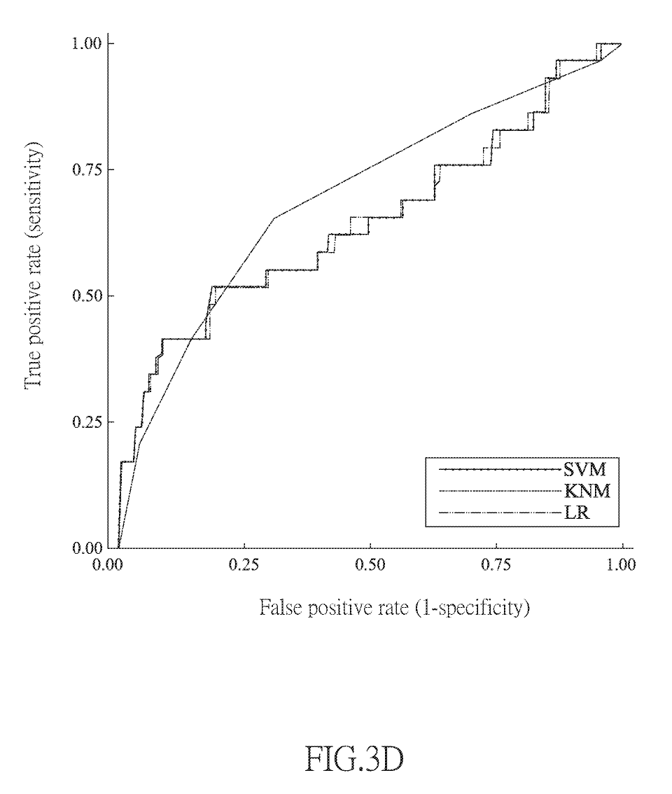

Referring to FIGS. 3A to 3D, the sample is taken from serum in this preferred embodiment. In the cancer screening, eight tumor markers including AFP, CEA, CA19-9, CYFRA21-1, SCC, PSA, CA15-3, and CA125 are analyzed as detailed below.

Conditions including eligible individuals, noninclusive items and numbers for screening are below. In the embodiment, the eligible individuals for screening are adults of at least 20 years old, and they are willing to pay fees for the analytical measurement of tumor markers.

Designs and methods: The main measurement values are test results of the above eight types of tumor markers. Data were obtained from a cancer registry to determine whether each patient had received a new diagnosis of malignancy within 1 year of the tumor markers test. Data records of the screening and diagnosis are analyzed to establish a plurality of machine learning models including LR, KNN, and SVM.

Data is collected between Jan. 1, 1999 and Dec. 31, 2013.

Result evaluation and statistics: Distribution of various tumor markers is calculated. A variable selection process is performed before the establishment of the machine learning models in order to select a plurality of robust variables. In the embodiment, robustness of the variables is evaluated by calculating AUC. Moreover, anticipation capabilities of respective models are determined based on internal verification. Thus, indices of performance evaluation including sensitivity, specificity, PPV, NPV and accuracy of the models are calculated.

FIG. 3A shows ROC curves of various single tumor markers for cancer screening (male), and FIG. 3B shows ROC curves of various machine learning models using multiple tumor markers for cancer screening (male) respectively. Logistic regression (LR), K nearest neighbor (KNN), and support vector machine (SVM) are shown in Table 1 below. In Table 1, CI means confidence interval. It is clear that the machine learning models using multiple tumor markers outperform all the single tumor markers for cancer screening. Tumor markers shown in Table 1 include AFP, CEA, CA19-9, CYFRA21-1, SCC, and PSA.

TABLE 1

| Classifier/tumor marker | AUC | 95% Cl |
|---|---|---|
| SVM | .726 | .621-.831 |
| KNN | .727 | .630-.825 |
| LR | .766 | .676-.856 |
| CYFRA21-1 | .657 | .562-.752 |
| CEA | .639 | .538-.741 |
| AFP | .607 | .507-.706 |
| CA19-9 | .599 | .498-.701 |
| PSA | .568 | .454-.682 |
| SCC | .514 | .418-.609 |

FIG. 3C shows ROC curves of various single tumor markers for cancer screening (female); and FIG. 3D shows ROC curves of various machine learning models using multiple tumor markers for cancer screening (female) respectively. It is clear that the machine learning models using multiple tumor markers outperform most of the single tumor markers except CYFRA21-1 for cancer screening. Tumor markers shown in Table 2 include AFP, CEA, CA19-9, CYFRA21-1, SCC, CA15-3, and CA125.

TABLE 2

| Classifier/tumor marker | AUC | 95% Cl |
|---|---|---|
| SVM | .650 | .529-.771 |
| KNN | .699 | .594-.804 |
| LR | .649 | .528-.770 |
| CYFRA21-1 | .651 | .530-.771 |
| SCC | .610 | .518-.703 |
| CA15-3 | .583 | .459-.708 |
| CA125 | .576 | .47-.679 |
| CA19-9 | .572 | .456-.688 |
| CEA | .531 | .394-.668 |
| AFP | .504 | .403-.605 |

Performances of the machine learning methods of the invention and the combined test of multiple tumor markers of the conventional art are shown in Tables 3 and 4 below. In Table 3, performances of the machine learning methods of the invention and the combined test of 6 tumor markers of the conventional art for male are shown. The performance of KNN is higher than or equal to that of the combined test of 6 tumor markers of the conventional art in terms of all the listed performance indices. The performance of SVM is significantly higher than that of the combined test of 6 tumor markers of the conventional art in terms of sensitivity and Youden index.

TABLE 3

| | Sensitivity | Specificity | PPV | NPV | Youden index |
|---|---|---|---|---|---|
| | (95% Cl) | (95% Cl) | (95% Cl) | (95% Cl) | (95% Cl) |
| SVM | .758 | .757 | .032 | .977 | .514 |
| | (.612-.904) | (.742-.772) | (.020-.044) | (.994-.999) | (.403-.626)** |
| KNN | .515 | .862 | .039 | .994 | .377 |
| | (.345-.686) | (.850-.874) | (.020-.057) | (.991-.997) | (.230-.524)** |
| LR | .485 | .859 | .036 | .994 | .344 |
| | (.315-.656) | (.847-.871) | (.019-.053) | (.991-.997) | (.197-.490) |
| Combined | .515 | .851 | .036 | .994 | .366 |
| test of 6 | (.345-.686) | (.838-.864) | (.019-.052) | (.991-.997) | (.220-.511) |
| tumor | | | | | |
| markers | | | | | |

In Table 4, performances of the machine learning methods of the invention and the combined test of 7 tumor markers of the conventional art for female are shown. The performance of the machine learning methods of the invention is significantly higher than that of the combined test of 7 tumor markers of the conventional art in terms of sensitivity and Youden index.

TABLE 4

| | Sensitivity | Specificity | PPV | NPV | Youden index |
|---|---|---|---|---|---|
| | (95% Cl) | (95% Cl) | (95% Cl) | (95% Cl) | (95% Cl) |
| SVM | .517 | .816 | .016 | .996 | .347 |
| | (.335-.699) | (.804-.828) | (.007-.025) | (.994-.998) | (.198-.500)** |
| KNN | .655 | .691 | .021 | .995 | .333 |
| | (.482-.828) | (.676-.706) | (.013-.029) | (.993-.998) | (.213-.453)** |
| LR | .517 | .758 | .016 | .995 | .275 |
| | (.335-.699) | (.744-.772) | (.008-.024) | (.992-.998) | (.137-.414)* |
| Combined | .345 | .880 | .022 | .994 | .225 |
| test of 7 | (.172-.518) | (.870-.890) | (.009-.035) | (.991-.997) | (.073-.377) |
| tumor | | | | | |
| markers | | | | | |

In view of Tables 3 and 4, it is found that cancer screening in a population consisting of males or females by using multiple tumor markers in the machine learning methods outperforms the combined test of 6 or 7 tumor markers of the conventional art. It is concluded that cancer screening conducted by the method of the invention can increase the performance of cancer screening.

The invention has the following characteristics and advantages: Convenience, economics and accuracy of cancer screening are increased greatly. A medical employee may know more about health and cancer risk of a patient by conducting a cancer screening in the patient by using multiple tumor markers. The invention can detect many types of cancer at a time. The number of test times can be largely reduced for the purpose of screening multiple types of cancer. Time required for cancer screening is shortened greatly as well. Possibility of excessive radiation and/or hurt of a patient are/is greatly decreased. An effective and safe model for anticipating cancer by using machine learning methods can be established because there are considerable amount of information contained in the tumor markers. Statistical analysis based on the test results can be performed. Thus, accuracy, time reduction, and correctness of cancer detection can be obtained.

While the invention has been described in terms of preferred embodiments, those skilled in the art will recognize that the invention can be practiced with modifications within the spirit and scope of the appended claims.

What is claimed is:

1. A method of establishing a machine learning model for cancer anticipation, the method comprising the steps of:
(A) collecting test results of a plurality of tumor markers of a plurality of eligible individuals and corresponding conditions of cancer into a machine learning model;
(B) performing a variable selection process on the collected data to select a plurality of robust variables; and
(C) using the selected variables, numerals, and conditions of cancer by cooperating with a machine learning method to establish a cancer anticipation model.

2. The method of claim 1, wherein the machine learning method is LR (logistic regression), KNN (K nearest neighbor), SVM (support vector machine), artificial neural network, decision tree, Bayes' theorem, or a combination of at least two of LR, KNN, SVM, artificial neural network, decision tree, and Bayes' theorem.

3. The method of claim 1, wherein the conditions of cancer include “cancerous” or “non-cancerous”, early stage or late stage, and types of cancer.

4. The method of claim 1, wherein the date of analytically measuring tumor markers of an eligible individual is one day to three years earlier than the date of determining the eligible individual having corresponding conditions of cancer.

5. The method of claim 1, wherein the machine learning model is established based on sensitivity, specificity, PPV (positive predictive value), NPV (negative predictive value), accuracy, AUC (area under the curve), and Youden Index for performance evaluation.

6. A method of detecting cancer by using a plurality of tumor markers in a machine learning model for cancer anticipation, the method comprising the steps of:
(A) collecting samples of an eligible individual;
(B) analytical measurement of a plurality of tumor markers in the collected samples to obtain test results;
(C) entering the test results into the machine learning model for analysis; and
(D) anticipating cancer risk of the eligible individual.

7. The method of claim 6, wherein the samples of the eligible individual include serum, urine, saliva, sweat, feces, chest fluid, abdominal fluid, and cerebrospinal fluid.

8. The method of claim 6, wherein the tumor markers include AFP (Alpha Fetal Protein), CEA (Carcinoembryonic Antigen), CA19-9 (Carbohydrate Antigen 19-9), CYFRA21-1 (Cytokeratin Fragment 21-1), SCC (Squamous Cell Carcinoma Antigen), PSA (Prostate Specific Antigen), CA15-3 (Carbohydrate Antigen), CA125 (Carbohydrate Antigen 125), EBV IgA (Epstein-Barr Virus IgA), CA27-29 (Carbohydrate Antigen), Beta-2-microglobulin, Beta-Hcg (Beta-human Chorionic Gonadotropin), CD 177 (Cluster of Differentiation 177), CD 20 (Cluster of Differentiation 20), CgA (Chromogranin A), HE 4 (Human Epididymis Secretory Protein 4), LDH (Lactate Dehydrogenase), Thyroglobulin, NSE (Neuron-specific Enolase), Nuclear Matrix Protein 22, and PD-L1 (Programmed Death Ligand 1).
